(19) United States
(12) Patent Application Publication
(10) Pub. No.: US 2008/0213723 A1
(43) Pub. Date: Sep. 4, 2008

(54) Medical/dental handpiece

(75) Inventors: Hitoshi Tanaka, Kyoto-shi (JP); Tetsuya Takashi, Kyoto-shi (JP); Shozo Nakayama, Kyoto-shi (JP)

Correspondence Address: Quinn Emanuel Urquhart Oliver & Hedges, LLP;Koda/Androlia, 865 S. Figueroa Street, 10th Floor, Los Angeles, CA, 90017, US

(73) Assignee: J. Morita Manufacturing Corporation

(21) Appl. No.: 12/069,985

(22) Filed: Feb. 14, 2008

(30) Foreign Application Priority Data
Feb. 21, 2007 (JP) P2007-040852
Feb. 21, 2007 (JP) P2007-040856

(51) Int. Cl. A61C 1/05

(52) U.S. Cl. 433/132

(57) ABSTRACT

An inventive medical/dental handpiece is characterized by including: a head part 2 that rotatably holds a rotor 24 for detachably holding a tool 91; and a gripped part 3 that supports, at its front end, the head part 2, and that is gripped by an operator, wherein the gripped part 3 includes a shank portion 31 extending from the head part 2, and a body portion 32 extending from a rear end of the shank portion 31 in the direction of an obtuse angle, wherein the axial flow turbine 5 is contained in the body portion 32, and wherein the handpiece further includes a rotation transmission mechanism for transmitting a rotation of the axial flow turbine 5 to rotate the rotor 24 of the head part 2.

### TECHNICAL FIELD

The present invention relates to contra-angle type medical/dental handpieces.

### BACKGROUND ART

As disclosed in Japanese Unexamined Patent Application Publication No. 61-73646 (hereinafter, called “Patent Document 1”), in a conventional contra-angle type medical/dental handpiece, a treatment tool at a head part is rotationally driven by an air motor. Furthermore, as disclosed in Japanese Examined Patent Application Publication No. 48-25799 (hereinafter, called “Patent Document 2”), a conventional medical/dental handpiece having an axial flow turbine is a straight type.

Generally, in a medical/dental handpiece, a rotation, which has been transmitted from a driving source to a transmission rotation shaft inside a gripped part, is transmitted via a pair of bevel gears to a holding shaft of a head part, thereby rotating the holding shaft together with a tool.

FIG. 24 shows a state in which a pair of conventional bevel gears 98, 99 are intermeshed. FIG. 25 is an upper perspective view of the intermeshed state shown in FIG. 24, and FIG. 26 is a diagram viewed in the direction indicated by the arrow XXVI of FIG. 24. In this conventional example, both tooth surfaces 991, 992 of each tooth 990 of a driven-side bevel gear 99 are formed into flat surfaces. However, as shown in FIGS. 27 to 29, extended planes 9910, 9920 extended from both of the flat surfaces, are in parallel with a rotational center axis B2 of the bevel gear 99.

### DISCLOSURE OF THE INVENTION

### Problems to be Solved by the Invention

In the handpiece disclosed in Patent Document 1, an air motor is used, which makes it hard to rotate the treatment tool at a high speed, thus making it difficult to carry out a sufficient treatment. Actually, in the handpiece disclosed in Patent Document 1, in order to increase the rotation speed of the treatment tool at the head part, it is necessary to reduce the pitch cone angle of a bevel gear provided in the head part. However, if the pitch cone angle of the bevel gear is reduced, the axial dimension of the bevel gear is increased, thus increasing the lengthwise dimension of the head part. If the lengthwise dimension of the head part is increased, it becomes difficult to carry out a treatment operation in an oral cavity. Accordingly, at any rate, it has been difficult to carry out a favorable treatment with the handpiece disclosed in Patent Document 1.

Therefore, in the present invention, it is an object of a first invention of the present application to provide a medical/dental handpiece capable of rotating, at a high speed, a tool held at a head part without increasing the dimension of the head part.

Since a pair of the conventional bevel gears 98, 99 are brought into the intermeshed state as shown in FIG. 26, tooth thickness E, tooth length F and tooth height G of each tooth of the bevel gear 98 all had to be designed to be small as shown in FIG. 30. Thus, the durability of each tooth 980 of the bevel gear 98 was low, and in addition, it was impossible to sufficiently intermesh both of the bevel gears 98, 99. Accordingly, in the conventional medical/dental handpiece, a pair of the bevel gears 98, 99 were unable to endure high-speed rotation, thus making it impossible to realize high-speed rotation of a tool.

Therefore, it is an object of a second invention of the present application to provide a medical/dental handpiece capable of rotating a tool at a high speed while improving the durability of bevel gears.

### Means of the Problems

The first invention of the present application provides a medical/dental handpiece having an axial flow turbine, the handpiece characterized by including: a head part that rotatably holds a holding shaft for detachably holding a tool; and a gripped part that supports, at its front end, the head part, and that is gripped by an operator, wherein the gripped part includes a shank portion extending from the head part, and a body portion extending from a rear end of the shank portion in the direction of an obtuse angle, wherein the axial flow turbine is contained in the gripped part, and wherein the handpiece further includes a rotation transmission mechanism for transmitting a rotation of the axial flow turbine to rotate the holding shaft of the head part.

The second invention of the present application provides a medical/dental handpiece including: a head part that rotatably holds a holding shaft for detachably holding a tool; and a gripped part that supports, at its front end, the head part, and that is gripped by an operator, the gripped part including a shank portion extending from the head part, and a body portion extending from a rear end of the shank portion in the direction of an obtuse angle, the handpiece characterized by further including a rotation transmission mechanism for transmitting a rotation from a driving source to rotate the holding shaft of the head part, wherein the rotation transmission mechanism has a pair of bevel gears for connecting the transmission rotation shaft, provided inside the gripped part, with the holding shaft of the head part, wherein rotational center axes of the pair of bevel gears are approximately orthogonal to each other, and are intersected at a first point, wherein both tooth surfaces of each tooth of one bevel gear are formed into flat surfaces, wherein both of the flat surfaces are formed so that extended planes extended from the flat surfaces intersect, at a second point, with an extension of the rotational center axis of said one bevel gear, and wherein the second point is located at the same side as the first point with respect to said one bevel gear.

### Effect of the Invention

According to the first invention of the present application, the tool held at the head part can be rotated via the rotation transmission mechanism by the axial flow turbine contained in the gripped part. In addition, since the large-sized axial flow turbine can be used, the tool can be rotated at a high speed, more specifically at 160000 rpm or more; furthermore, it is possible to achieve a torque about 1.5 to 2 times higher than that of an air motor used in the conventional contra-angle type medical/dental handpiece.

According to the second invention of the present application, the tooth thickness, tooth length and tooth height of each tooth of the other bevel gear can be all designed to be large. Hence, the durability of each tooth of the other bevel gear can be considerably improved; in addition, the other bevel gear can be sufficiently intermeshed with one of the bevel gears, and the intermeshed surface can be located on a pitch cone. Accordingly, in a pair of the bevel gears of the present invention, wear, oscillation and the like can be suppressed. Furthermore, the bevel gears used in the medical/dental handpiece each have a very small size; however, one of the bevel gears can be fabricated with a simple cutting process by forming tooth surfaces of each tooth into flat surfaces, and the other bevel gear can also be fabricated with a simple cutting process because the tooth thickness, tooth length and tooth height of each tooth can be designed to be large.

### BRIEF DESCRIPTION OF THE DRAWINGS

FIG. 1 is an overall external view of a medical/dental handpiece according to an embodiment of the present invention.

FIG. 2 is a cross-sectional view of the handpiece shown in FIG. 1.

FIG. 3 is an enlarged cross-sectional view of a head part shown in FIG. 2.

FIG. 4 is an enlarged cross-sectional view of an axial flow turbine shown in FIG. 2.

FIG. 5 is an exploded cross-sectional view of the axial flow turbine shown in FIG. 2.

FIG. 6 is a perspective view of an upstream side collar portion of the axial flow turbine shown in FIG. 4.

FIG. 7 is a perspective view of a downstream side collar portion of the axial flow turbine shown in FIG. 4.

FIG. 8 is an enlarged perspective view for describing an introduction nozzle main body portion of an introduction nozzle shown in FIG. 4.

FIG. 9 is an enlarged perspective view of the introduction nozzle having the introduction nozzle main body portion shown in FIG. 8.

FIG. 10 is a perspective view of an introduction nozzle according to the present embodiment.

FIG. 11 is a downstream perspective view of an introduction nozzle main body portion of the introduction nozzle shown in FIG. 10.

FIG. 12 is an upstream perspective view of the introduction nozzle main body portion of the introduction nozzle shown in FIG. 10.

FIG. 13 is a lateral view of a guide nozzle shown in FIG. 4.

FIG. 14 is a lateral view of a guide nozzle main body portion of the guide nozzle shown in FIG. 13.

FIG. 15 is an upstream perspective view of the guide nozzle main body portion shown in FIG. 14.

FIG. 16 is a downstream perspective view of the guide nozzle main body portion shown in FIG. 14.

FIG. 17 is a lateral view of a third bevel gear and a fourth bevel gear shown in FIG. 3.

FIG. 18 is a lower perspective view of the fourth bevel gear shown in FIG. 17.

FIG. 19 is an upper perspective view of the fourth bevel gear shown in FIG. 17.

FIG. 20 is a perspective view in which extended planes of tooth surfaces are additionally drawn to the fourth bevel gear shown in FIG. 17.

FIG. 21 is a diagram showing a point of intersection of the extended planes and a rotational center axis of the fourth bevel gear, which are shown in FIG. 20.

FIG. 22 is a diagram viewed in the direction indicated by the arrow XXII of FIG. 17.

FIG. 23 is a perspective view of the third bevel gear according to the present embodiment.

FIG. 24 is a lateral view showing a state in which a pair of conventional bevel gears are intermeshed.

FIG. 25 is an upper perspective view of the intermeshed state shown in FIG. 24.

FIG. 26 is a diagram viewed in the direction indicated by the arrow XXVI of FIG. 24.

FIG. 27 is a perspective view in which extended planes of tooth surfaces are additionally drawn to the driven-side bevel gear shown in FIG. 24.

FIG. 28 is an opposite perspective view of FIG. 27.

FIG. 29 is a front view of FIG. 27.

FIG. 30 is a perspective view of the driving-side bevel gear shown in FIG. 24.

FIG. 31 is a cross-sectional view of a handpiece according to another example of the present embodiment.

### BEST MODE FOR CARRYING OUT THE INVENTION

Hereinafter, a medical/dental handpiece according to an embodiment of the present invention will be described with reference to the drawings.

(1) Structure of Medical/Dental Handpiece of Present Embodiment

(1-1) Overall Structure

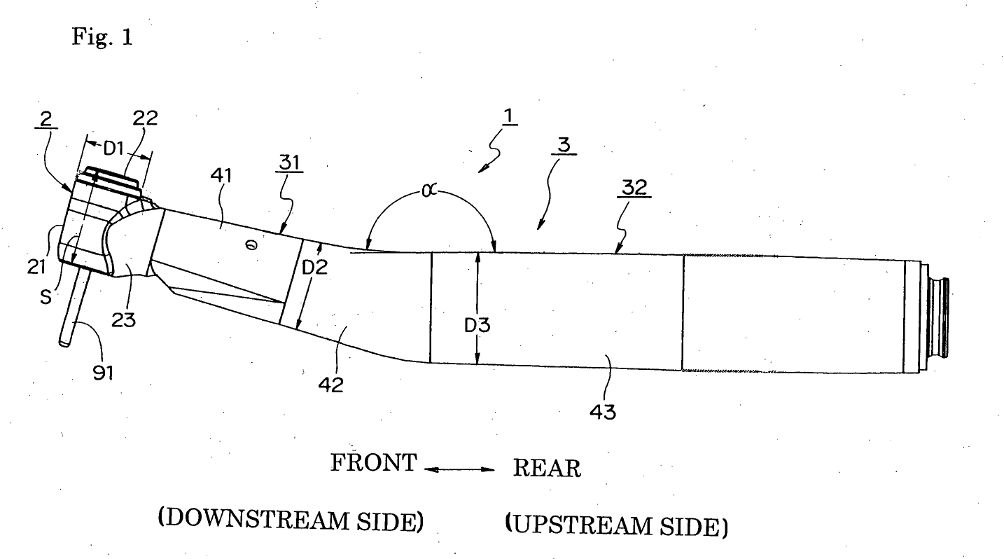

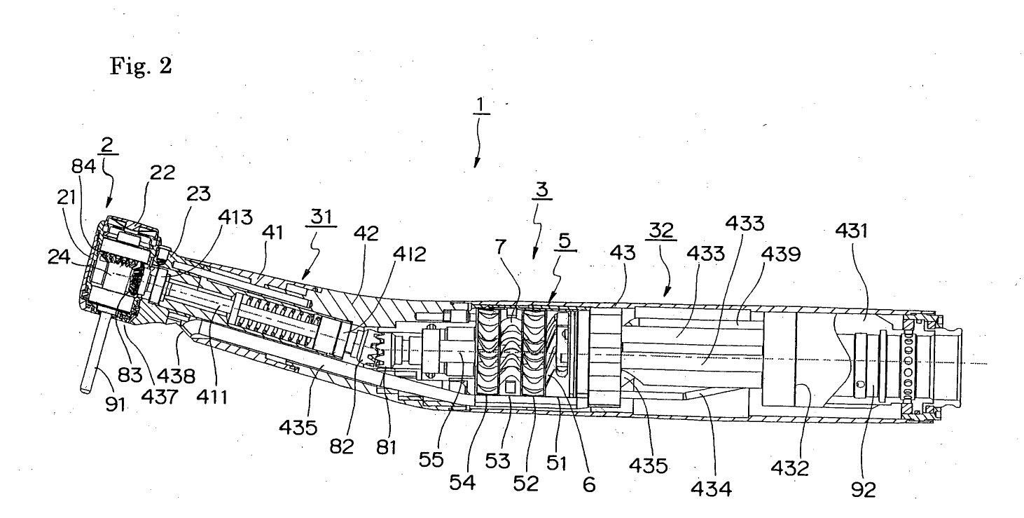

FIG. 1 is an overall external view of the medical/dental handpiece, and FIG. 2 is a cross-sectional view of the handpiece 1 shown in FIG. 1.

This handpiece 1 is a contra-angle type, and includes: a head part 2 for rotatably holding a treatment tool 91; and a gripped part 3 to be gripped by an operator. The gripped part 3 has a size that allows an operator to carry out an operation with the gripped part 3 held in his or her hand. The head part 2 is supported at a front end of the gripped part 3. The gripped part 3 includes: a shank portion 31 extended from the head part 2; and a body portion 32 extended from a rear end of the shank portion 31 in the direction of an obtuse angle (i.e., an angle α in FIG. 1). It should be noted that α is greater than 90 degrees but smaller than 180 degrees. A diameter D1 of the head part 2, a diameter D2 of the shank portion 31, and a diameter D3 of the body portion 32 have a relationship represented by the following formula: D1<D2<D3.

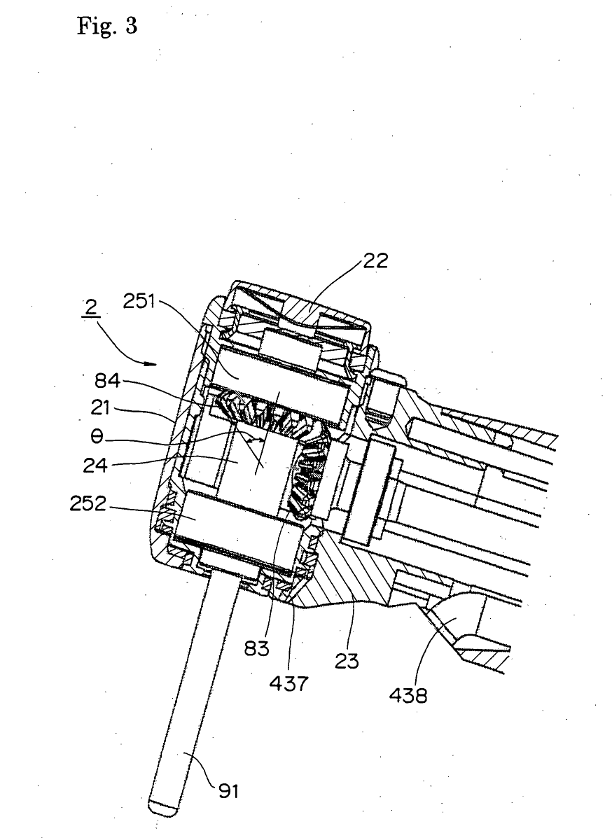

FIG. 3 is an enlarged cross-sectional view of the head part 2. The outer shape of the head part 2 is formed by: a tubular housing 21; a lid portion 22 for closing the housing 21 from above; and a neck portion 23 extending laterally from the housing 21. On the other hand, as shown in FIG. 2, the outer shape of the gripped part 3 is formed by three tubular housings, i.e., a front housing 41, a center housing 42, and a rear housing 43. It should be noted that the outer shape of the shank portion 31 is formed by the front housing 41 and the center housing 42, while the outer shape of the body portion 32 is formed by the rear housing 43.

Further, the neck portion 23 of the head part 2 is fitted into a front end portion of the front housing 41, thus supporting the head part 2 at the front end of the gripped part 3. Furthermore, a front end portion of the center housing 42 is fitted into a rear end portion of the front housing 41, while a rear end portion of the center housing 42 is fitted into a front end portion of the rear housing 43. Thus, the three housings 41, 42 and 43 integrally constitute the outer shape of the gripped part 3.

At the head part 2, a rotor (holding shaft) 24 for detachably holding the treatment tool 91 is held rotatably via bearings 251, 252. The rotor 24 is integrally formed with a fourth bevel gear 84.

At the gripped part 3, a rear end portion of the rear housing 43 is formed with an insertion hole 431 into which an air supply/water supply connector 92 is inserted and connected. From a downstream end face 432 of the insertion hole 431, an air supply tube 433, a water supply tube 434 and a light guide tube 435 are extended forward. In addition, the front end portion inside the rear housing 43 is provided with an axial flow turbine 5.

The axial flow turbine 5 includes an introduction nozzle 51, a first turbine rotor 52, a guide nozzle 53, and a second turbine rotor 54 in this order from the rear. The introduction nozzle 51 has one or more introduction nozzle passages 6, through which air flow supplied from the air supply tube 433 is constricted and introduced into the first turbine rotor 52, and is fixed within the gripped part 3. The guide nozzle 53 has one or more guide nozzle passages 7, through which the air flow discharged from the first turbine rotor 52 is guided to the second turbine rotor 54, and is fixed within the gripped part 3. The axial flow turbine 5 rotates the first turbine rotor 52 and the second turbine rotor 54 around the longitudinal axis of the handpiece 1, thereby rotating a turbine rotation shaft 55.

The gripped part 3 is provided with a rotation transmission mechanism for transmitting a rotation of the axial flow turbine 5 to the rotor 24. The rotation transmission mechanism is formed so as to transmit the rotation of the axial flow turbine 5 to the rotor 24 of the head part 2 via the turbine rotation shaft 55, a first bevel gear 81, a second bevel gear 82, a transmission rotation shaft 411, a third bevel gear 83 and the fourth bevel gear 84.

The turbine rotation shaft 55 is extended to an approximately intermediate position of the center housing 42. Further, the turbine rotation shaft 55 is provided at its extremity with the first bevel gear 81.

The transmission rotation shaft 411 is rotatably held at the center housing 42 and the front housing 41 via bearings 412, 413. The transmission rotation shaft 411 is extended from the approximately intermediate position of the center housing 42 to the neck portion 23 of the head part 2. Further, the transmission rotation shaft 411 is provided at its rear end with the second bevel gear 82. The second bevel gear 82 is intermeshed with the first bevel gear 81 from the direction of the angle α (in FIG. 1). On the other hand, the transmission rotation shaft 411 is provided at its front end with the third bevel gear 83. The third bevel gear 83 is approximately orthogonally intermeshed with the fourth bevel gear 84.

The water supply tube 434 is extended forward from the downstream end face 432 of the insertion hole 431 through the gripped part 3, and is led to a water injection opening 437 located at a lower face of the head part 2.

The light guide tube 435 is extended forward from the downstream end face 432 of the insertion hole 431 through the gripped part 3, and is led to an irradiation opening 438 located at a lower face side of the front housing 41.

(1-2) Lubricating Oil Supply Mechanism

The handpiece 1 has a lubricating oil supply mechanism. The lubricating oil supply mechanism includes: a lubricating oil supply tube 439 provided in the body portion 32; a hollow inner portion of the turbine rotation shaft 55; and a hollow inner portion of the transmission rotation shaft 411. A rear end of the lubricating oil supply tube 439 is connected to a lubricating oil supply opening (not shown) opened in the rear housing 43. A front end of the lubricating oil supply tube 439 is connected to a rear end of the turbine rotation shaft 55. The hollow inner portion of the turbine rotation shaft 55 is opened in the first bevel gear 81, and the hollow inner portion of the transmission rotation shaft 411 is opened in the third bevel gear 83.

(1-3) Axial Flow Turbine 5

(1-3-1) Overall Structure

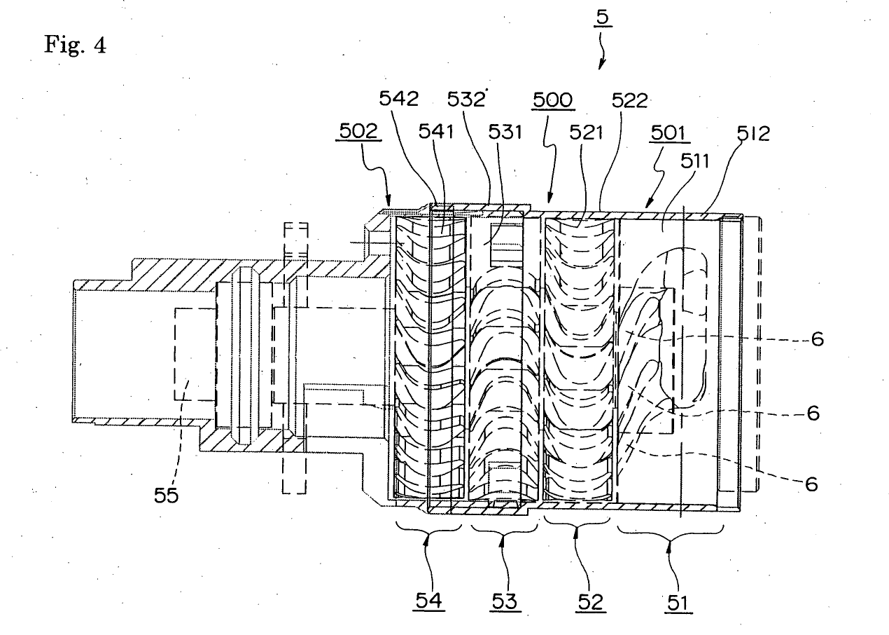

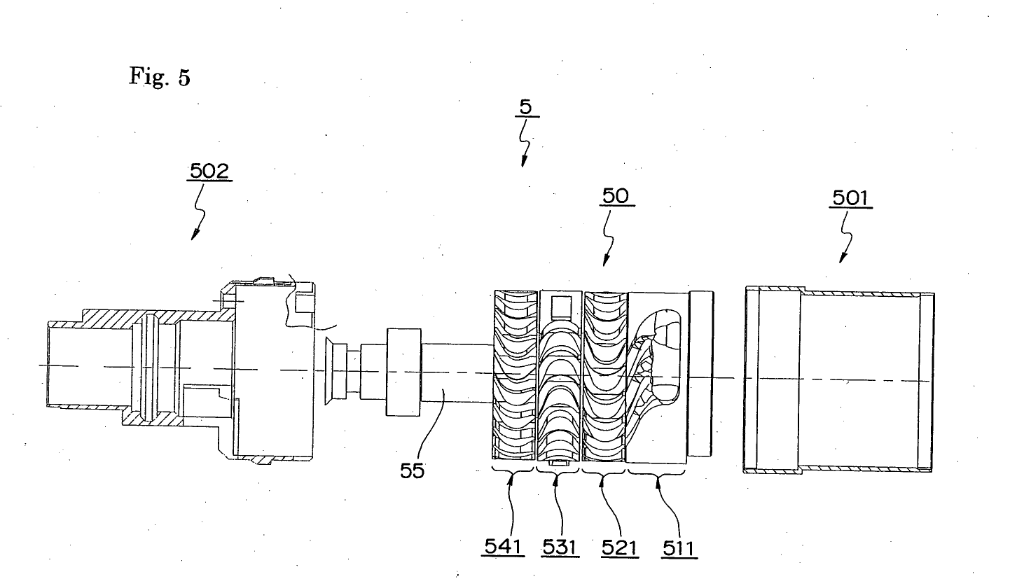

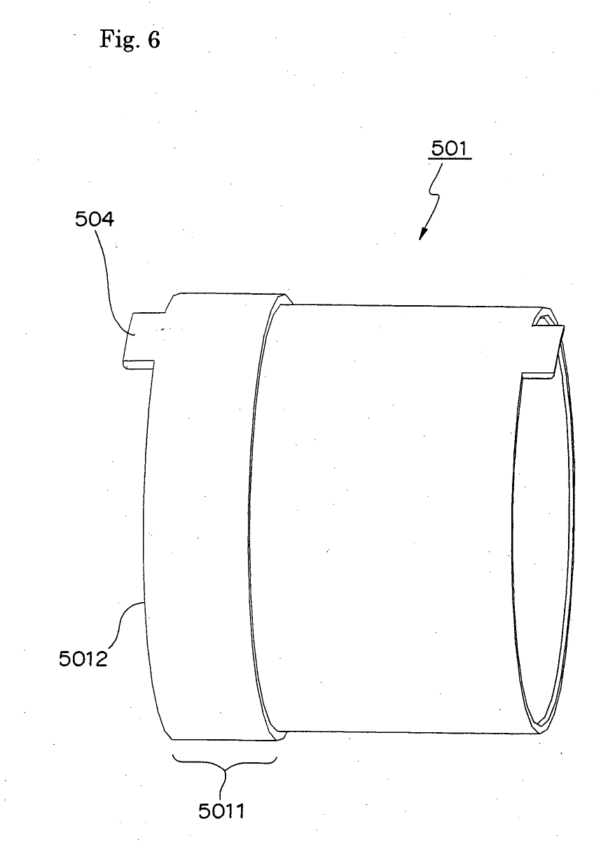

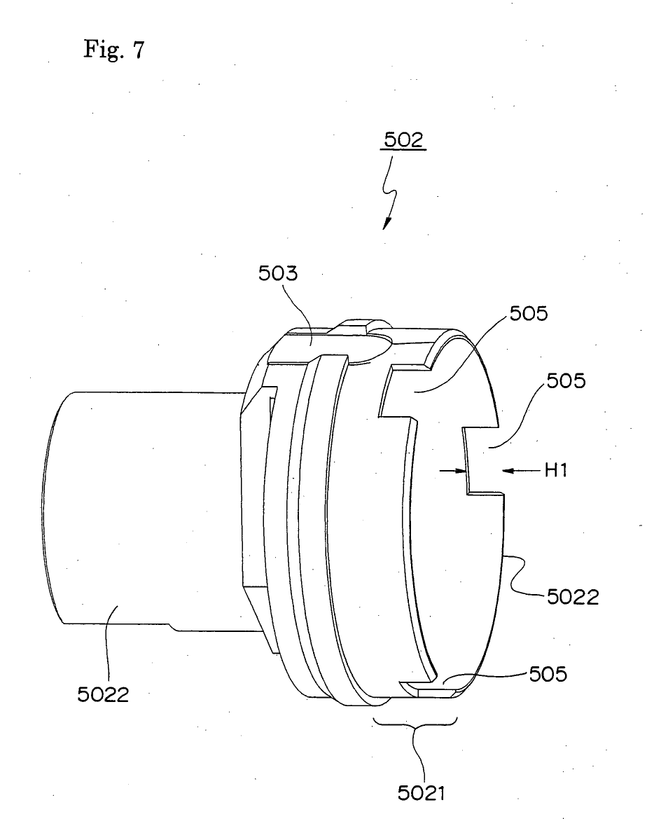

FIG. 4 is an enlarged cross-sectional view of the axial flow turbine 5, and FIG. 5 is an exploded cross-sectional view of the axial flow turbine 5. The axial flow turbine 5 includes: a main body portion 50; and a cylindrical collar 500 externally fitted to the main body portion 50. In this embodiment, the collar 500 is divided into an upstream side collar portion 501 and a downstream side collar portion 502. FIG. 6 is a perspective view of the upstream side collar portion 501, and FIG. 7 is a perspective view of the downstream side collar portion 502.

On the other hand, the introduction nozzle 51 includes an introduction nozzle main body portion 511 and an introduction collar portion (i.e., introduction nozzle collar) 512, the first turbine rotor 52 includes a first turbine main body portion 521 and a first collar portion 522, the guide nozzle 53 includes a guide nozzle main body portion 531 and a guide collar portion 532, and the second turbine rotor 54 includes a second turbine main body portion 541 and a second collar portion 542. Further, the introduction nozzle main body portion 511, the first turbine main body portion 521, the guide nozzle main body portion 531 and second turbine main body portion 541 constitute the main body portion 50 of the axial flow turbine 5. Furthermore, the introduction collar portion 512, the first collar portion 522 and a part of the guide collar portion 532 integrally constitute the upstream side collar portion 501, while a part of the guide collar portion 532 and the second collar portion 542 integrally constitute the downstream side collar portion 502. It should be noted that a downstream side end portion 5011 (FIG. 6) of the upstream side collar portion 501 overlaps with an upstream side end portion 5021 (FIG. 7) of the downstream side collar portion 502 at parts of the guide nozzle 53 and the second turbine rotor 54, and the downstream side end portion 5011 is located externally. Furthermore, a small diameter portion 5022 at the downstream side of the downstream side collar portion 502 covers the turbine rotation shaft 55.

(1-3-2) Introduction Nozzle 51

The introduction nozzle 51 has the three introduction nozzle passages 6. The introduction nozzle passages 6 are formed as described below.

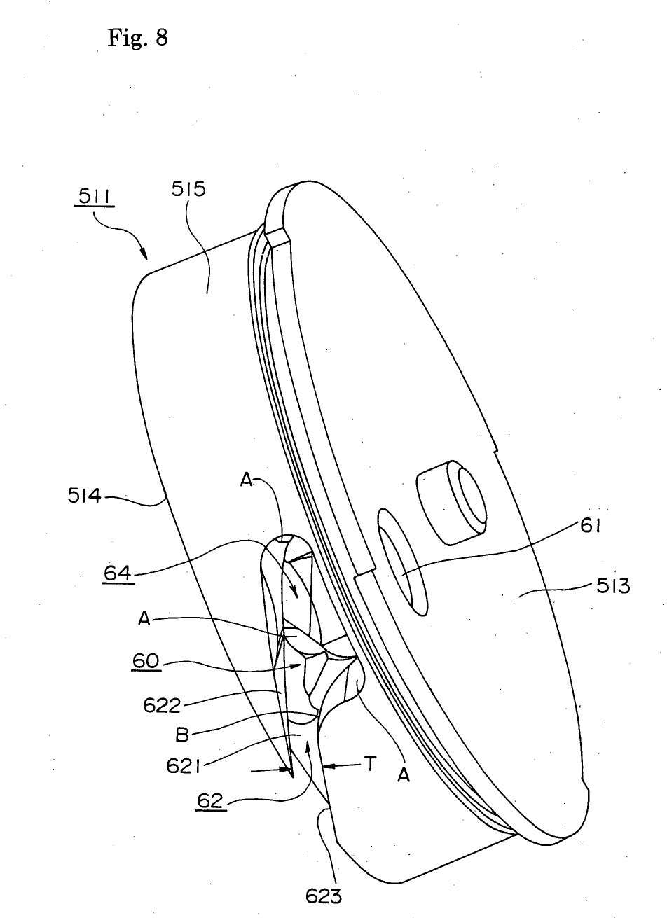

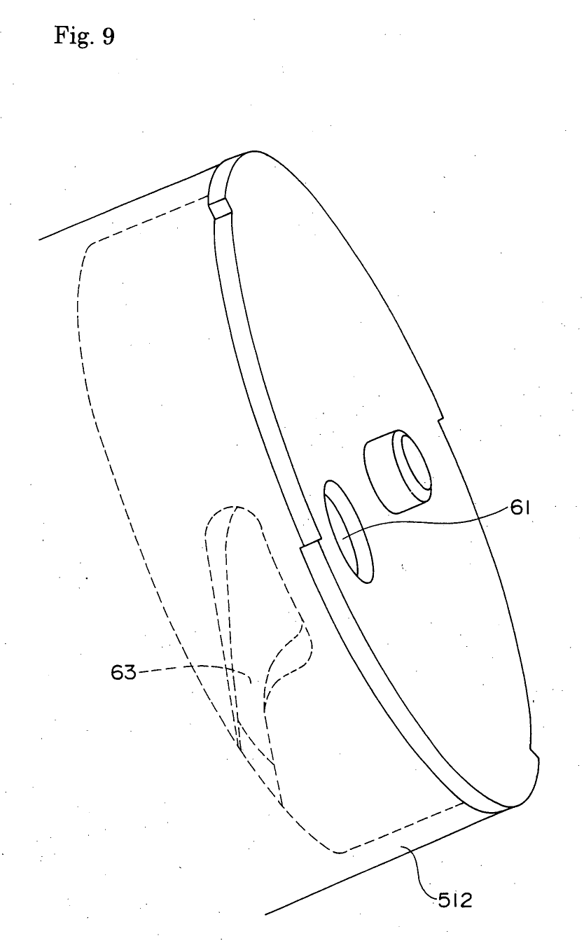

FIG. 8 is an enlarged perspective view for describing the introduction nozzle main body portion 511. In FIG. 8, there is shown one fluid passage 60 constituting one introduction nozzle passage 6. The introduction nozzle main body portion 511 is formed with the fluid passage 60 leading from an upstream side end face 513 to a downstream side end face 514. The fluid passage 60 is formed by connecting a first hole portion 61, formed from the upstream side end face 513, with a groove portion 62 formed along a circumferential face 515 of the introduction nozzle main body portion 511 from the downstream side end face 514. The groove portion 62 is formed so as to be inclined, i.e., so as to create a spiral path, with respect to the axial direction of the introduction nozzle main body portion 511. Furthermore, the groove portion 62 is closed by the introduction collar portion 512 externally fitted to the introduction nozzle main body portion 511, thereby forming a second hole portion 63 as shown in FIG. 9. Thus, the first hole portion 61 and the second hole portion 63 constitute the introduction nozzle passage 6.

The groove portion 62 is formed by a bottom face 621, and both lateral faces 622, 623, and the bottom face 621 becomes shallower as it approaches the downstream side end face 514. In addition, in the groove portion 62, a space T between both the lateral faces 622 and 623 becomes smaller as it approaches the downstream side end face 514.

Moreover, a connecting portion 64 of the first hole portion 61 and the second hole portion 63 is enlarged to constitute a fluid accumulation portion. At a connection between the connecting portion (i.e., fluid accumulation portion) 64 and the groove portion 62, portions A are approximately C-chamfered, and a portion B is approximately R-chamfered.

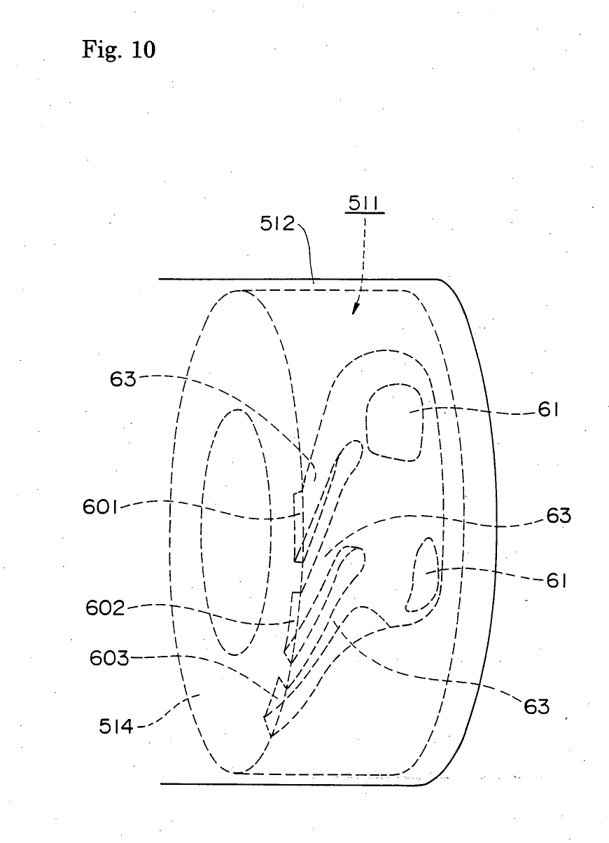

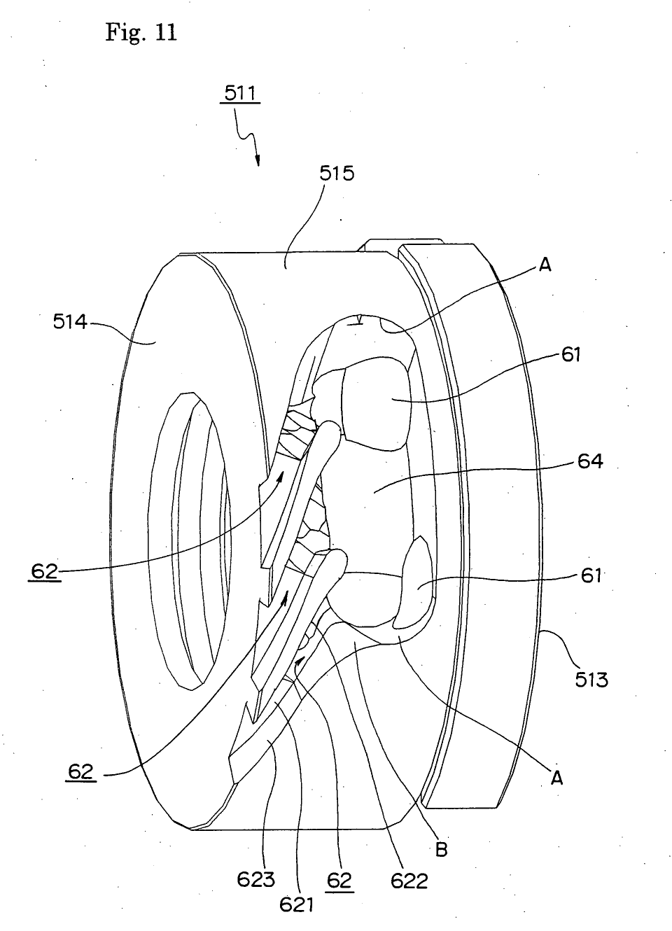

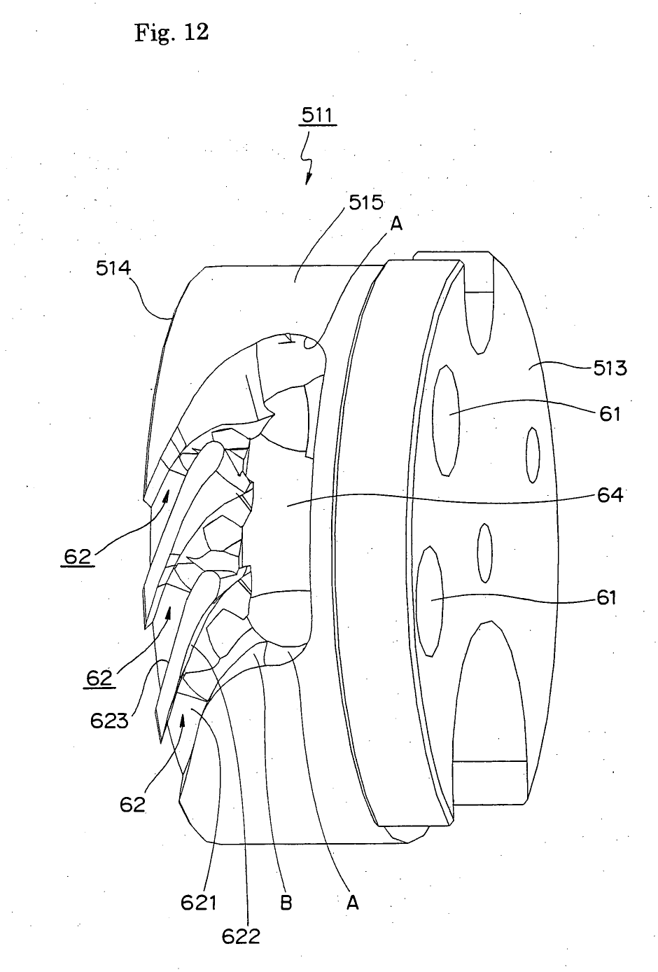

It should be noted that in the example shown in FIG. 9, one introduction nozzle passage 6 is formed by one first hole portion 61 and one second hole portion 63. Therefore, in the case of forming a plurality of the introduction nozzle passages 6 in the introduction nozzle 51, a plurality of the introduction nozzle passages 6 shown in FIG. 9 may be formed. However, a plurality of the introduction nozzle passages 6 may alternatively be formed as follows. Specifically, the first hole portion 61 is shared, and a plurality of the second hole portions 63 are provided from the shared first hole portion 61. FIG. 10 is a perspective view of the introduction nozzle 51 of the present embodiment, showing the case where the two first hole portions 61 are shared, and the three second hole portions 63 are provided from the shared first hole portions 61. FIG. 11 is a downstream perspective view of the introduction nozzle main body portion 511 of the introduction nozzle 51 shown in FIG. 10, and FIG. 12 is an upstream perspective view of the introduction nozzle main body portion 511 of the introduction nozzle 51.

Furthermore, in the introduction nozzle 51 of the present embodiment, the areas of respective openings 601, 602 and 603 at the downstream side end face 514 of the three introduction nozzle passages 6 are equal to each other.

(1-3-3) Guide Nozzle 53

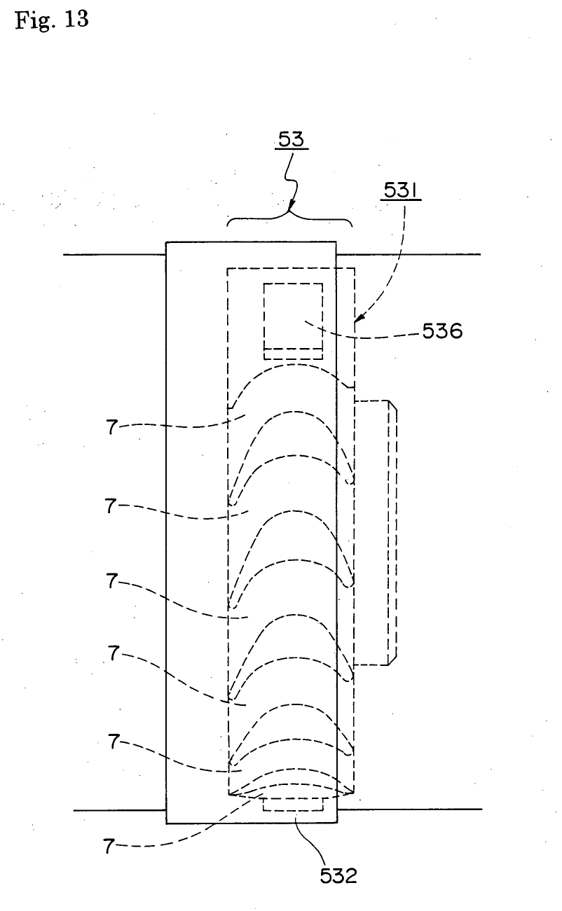

FIG. 13 is a lateral view of the guide nozzle 53. The guide nozzle 53 includes: a disk-shaped guide nozzle main body portion 531; and a cylindrical collar portion (i.e., guide nozzle collar) 532 externally fitted to the guide nozzle main body portion 531. It should be noted that the collar portion 532 is formed by the overlapping of the downstream side end portion 5011 of the upstream side collar portion 501 with the upstream side end portion 5021 of the downstream side collar portion 502 as mentioned above. Further, the guide nozzle 53 has six guide nozzle passages 7. The guide nozzle passages 7 are formed as follows.

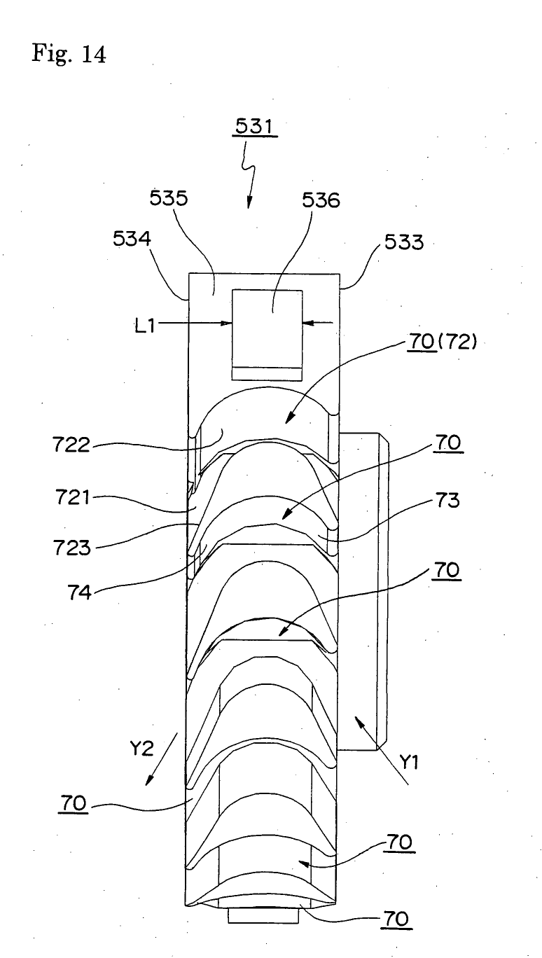

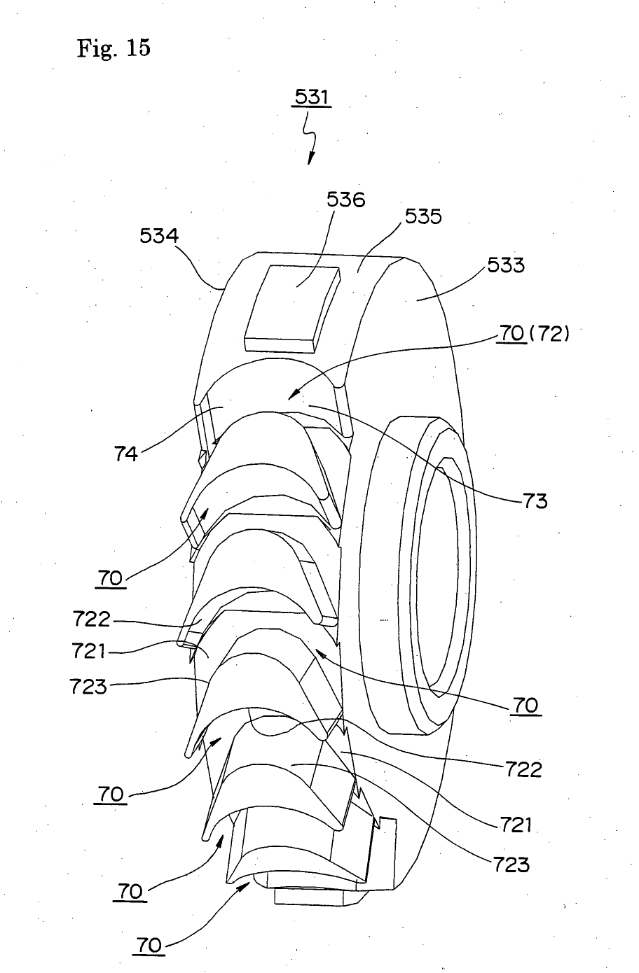

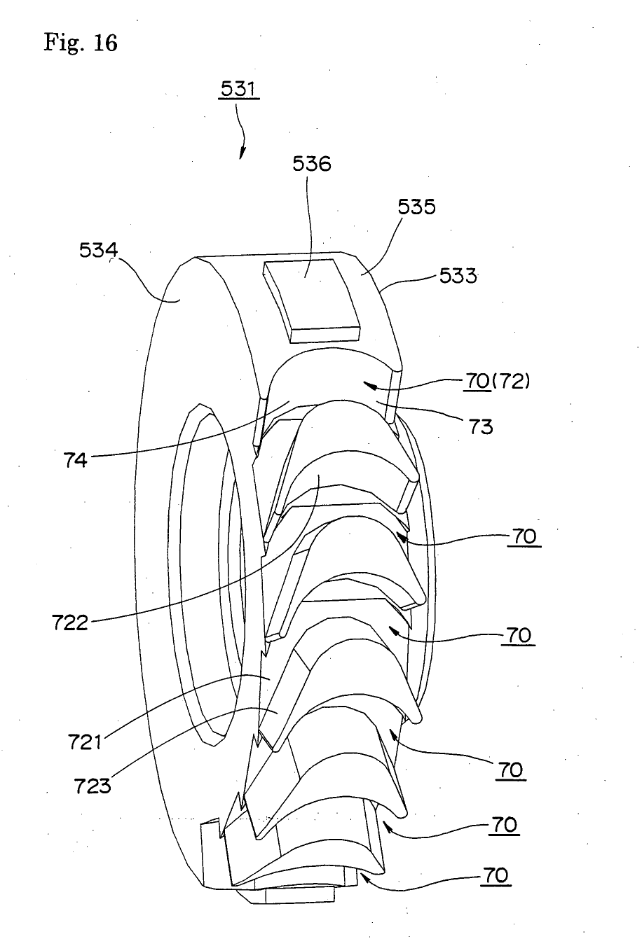

FIG. 14 is a lateral view of the guide nozzle main body portion 531, FIG. 15 is an upstream perspective view of the guide nozzle main body portion 531, and FIG. 16 is a downstream perspective view of the guide nozzle main body portion 531. The guide nozzle main body portion 531 has six fluid passages 70 leading from an upstream side end face 533 to a downstream side end face 534. The fluid passages 70 each include a groove portion 72 formed along a circumferential face 535 of the guide nozzle main body portion 531. The groove portions 72 each have a bottom face 721, and both lateral faces 722, 723. Further, the groove portions 72 are each formed by connecting an upstream side groove portion 73 with a downstream side groove portion 74. Furthermore, the upstream side groove portions 73 are each inclined as indicated by the arrow Y1 with respect to the axial direction so as to be approximately in parallel with the inclination direction of a downstream side portion of each blade of the first turbine rotor 52 with respect to the axial direction. On the other hand, the downstream side groove portions 74 are each inclined as indicated by the arrow Y2 with respect to the axial direction so as to be approximately in parallel with the inclination direction of an upstream side portion of each blade of the second turbine rotor 54 with respect to the axial direction. In addition, the groove portions 72, i.e., the fluid passages 70, are closed by the guide collar portion 532 externally fitted to the guide nozzle main body portion 531, thereby constituting the guide nozzle passages 7 as shown in FIG. 13.

Moreover, the guide nozzle 53 has a convex portion 536 at the circumferential face 535 of the guide nozzle main body portion 531. In the present embodiment, the three convex portions 536 are provided at equal intervals in the circumferential direction of the circumferential face 535.

(1-3-4) Collar 500

A downstream side edge 5012 of the upstream side collar portion 501 is formed with a protrusive piece 504 fitted to a concave portion 503 formed at a circumferential face of the downstream side collar portion 502. Further, an upstream side edge 5022 of the downstream side collar portion 502 is formed with three cutout portions 505 externally fitted to the three convex portions 536 of the guide nozzle 53. A depth H1 of each cutout portion 505 is equal to an axial length L1 of each convex portion 536.

The collar 500 is formed by allowing, from the downstream side, the downstream side collar portion 502 to be externally fitted to the main body portion 50, and allowing the cutout portions 505 to be externally fitted to the convex portions 536, and then by allowing, from the upstream side, the upstream side collar portion 501 to be externally fitted to the main body portion 50, allowing the downstream side end portion 5011 to be superposed on the upstream side end portion 5021, and allowing the protrusive piece 504 to be fitted to the concave portion 503. Thus, the collar 500 is fixed to the main body portion 50.

(1-4) Third Bevel Gear 83 and Fourth Bevel Gear 84

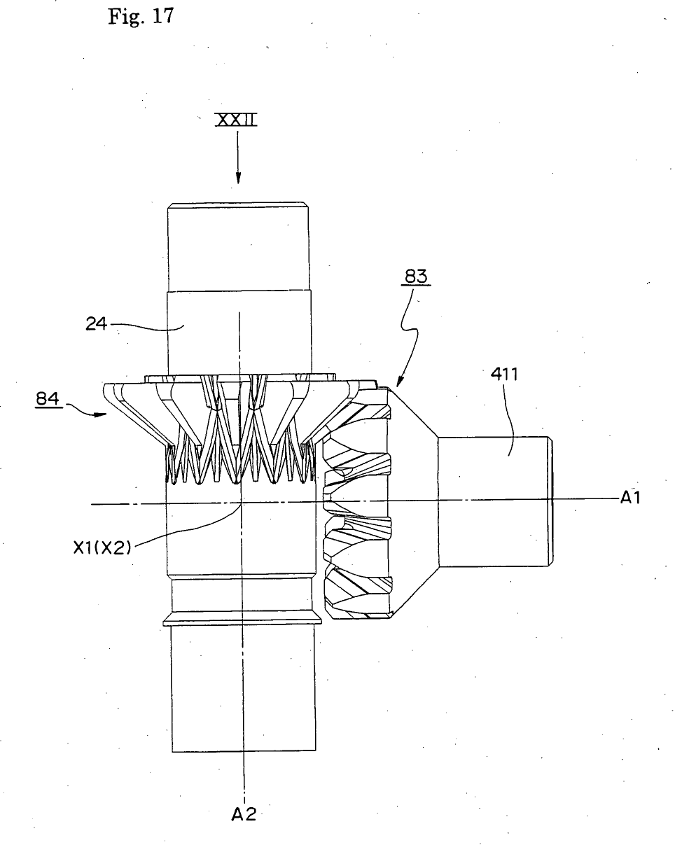

FIG. 17 is an enlarged lateral view of the third bevel gear 83 and the fourth bevel gear 84. A rotational center axis A1 of the third bevel gear 83 and a rotational center axis A2 of the fourth bevel gear 84 are approximately orthogonal to each other, and are intersected at a point X1.

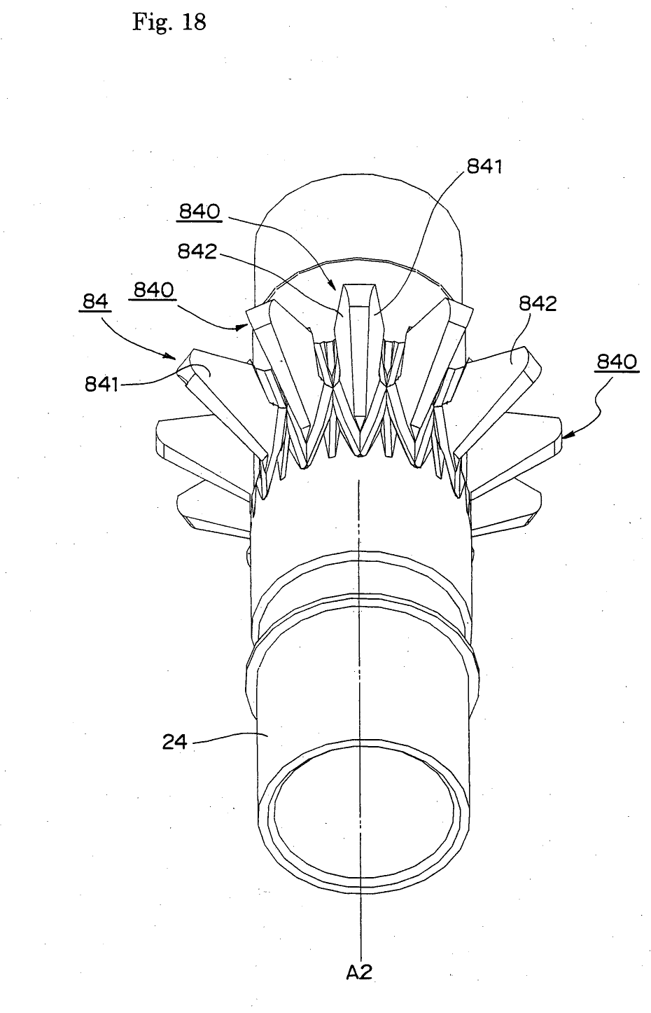

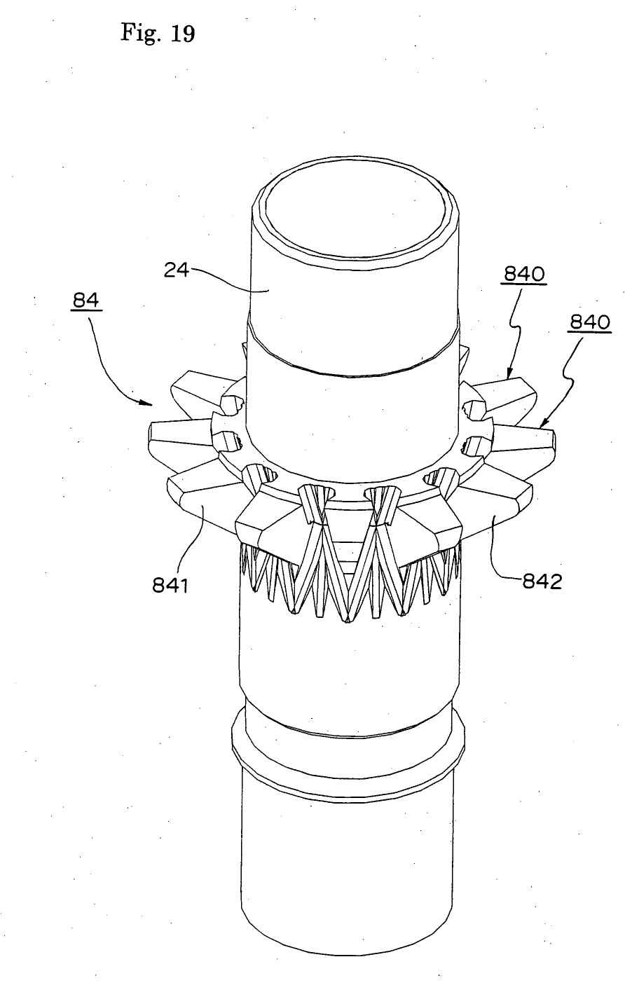

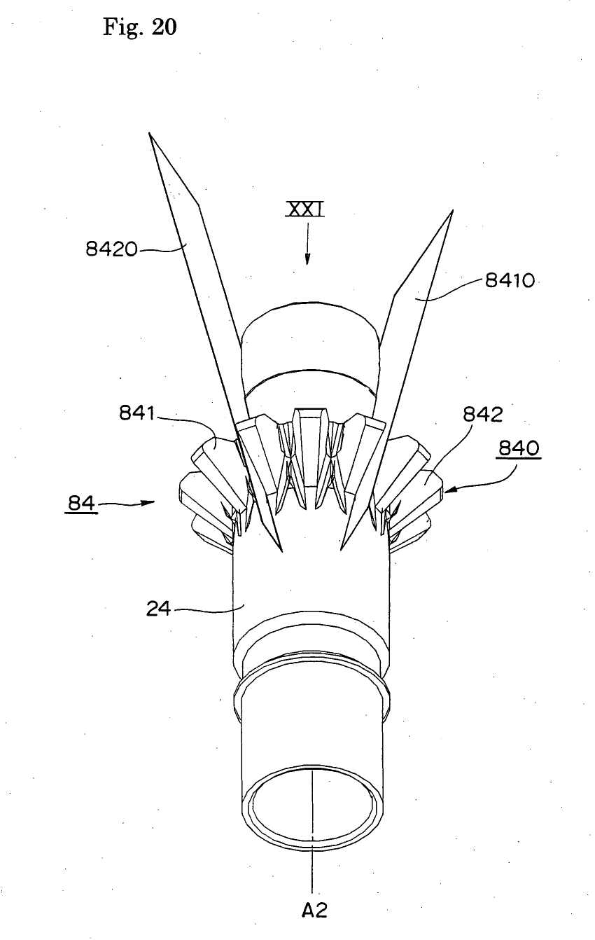

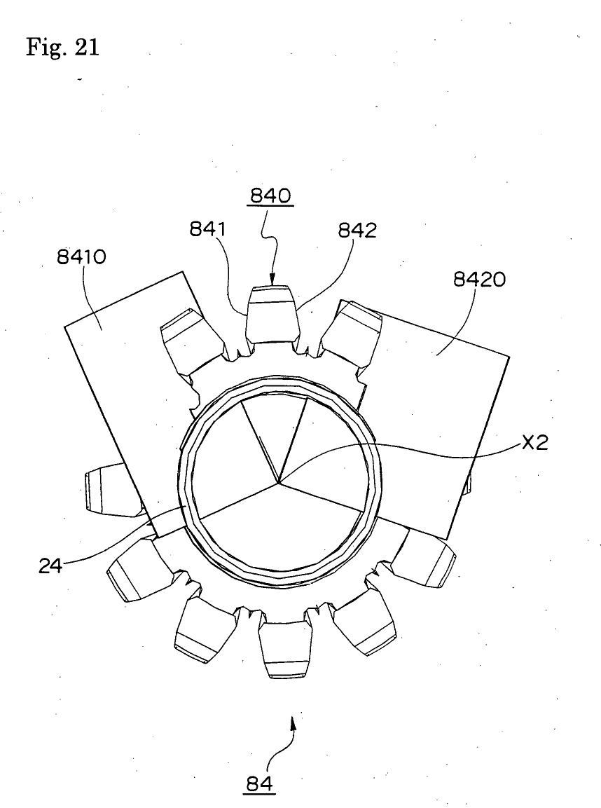

FIG. 18 is a lower perspective view of the fourth bevel gear 84, and FIG. 19 is an upper perspective view of the fourth bevel gear 84. The fourth bevel gear 84 is formed integrally with the rotor 24. Both tooth surfaces 841, 842 of each tooth 840 of the fourth bevel gear 84 are formed into flat surfaces. Further, as shown in FIGS. 20 and 21, both of these flat surfaces are formed so that extended planes 8410, 8420 extended therefrom intersect, at a point X2, with an extension of the rotational center axis A2 of the fourth bevel gear 84. It should be noted that FIG. 21 is a diagram viewed in the direction indicated by the arrow XXI of FIG. 20. The point X2 is located at the same side as the point X1 with respect to the fourth bevel gear 84. In this embodiment, the point X1 coincides with the point X2.

(2) Operations and Effects of Medical/Dental Handpiece of Present Embodiment

Hereinafter, operations and effects of the handpiece 1 with the above-described structure will be described.

(2-1) Overall Operations and Effects

In the state where the treatment tool 91 is held at the head part 2 and the connector 92 is connected to the insertion hole 431 of the gripped part 3, upon turning on of a switch (not shown), air flow is supplied toward the axial flow turbine 5 through the air supply tube 433, water is supplied toward the water injection opening 437 through the water supply tube 434, and light is guided toward the irradiation opening 438 through the light guide tube 435.

The air flow, which has reached the axial flow turbine 5, is constricted and increased in speed by the introduction nozzle 51, and is introduced into the first turbine rotor 52. Thus, the first turbine main body portion 521 of the first turbine rotor 52 is rotated. Then, the air flow is discharged from the first turbine rotor 52, and is guided to the second turbine rotor 54 by the guide nozzle 53. Thus, the second turbine main body portion 541 of the second turbine rotor 54 is rotated. Consequently, the turbine rotation shaft 55 is rotated.

The rotation of the turbine rotation shaft 55 is transmitted to the transmission rotation shaft 411 via the intermeshing of the first bevel gear 81 and the second bevel gear 82. Thus, the transmission rotation shaft 411 is rotated.

The rotation of the transmission rotation shaft 411 is transmitted to the rotor 24 via the intermeshing of the third bevel gear 83 and the fourth bevel gear 84. Thus, the rotor 24 rotates while holding the tool 91.

On the other hand, the water supplied through the water supply tube 434 is ejected from the water injection opening 437 toward the extremity of the tool 91, and the light guided through the light guide tube 435 is irradiated from the irradiation opening 438 toward the extremity of the tool 91.

As stated above, in the handpiece 1 with the above-described structure, the tool 91 can be rotated via the rotation transmission mechanism by the axial flow turbine 5 contained in the body portion 32 of the gripped part 3.

Actually, the large-sized axial flow turbine 5 can be contained in the body portion 32 because the diameter D3 thereof is larger than the diameter D1 of the head part 2. Therefore, in the handpiece 1 with the above-described structure, the turbine rotation shaft 55 can be rotated at a high speed by the large-sized axial flow turbine 5, the transmission rotation shaft 411 can be rotated at a high speed via the first bevel gear 81 and the second bevel gear 82, and furthermore, the rotor 24 can be rotated at a high speed, more specifically at 160000 rpm or more, via the third bevel gear 83 and the fourth bevel gear 84.

Furthermore, in the handpiece 1 with the above-described structure, the transmission rotation shaft 411 can be rotated at a high speed, and therefore, there is no need to significantly increase the speed by the third bevel gear 83 and the fourth bevel gear 84. Accordingly, in the handpiece 1 with the above-described structure, the number of teeth of the third bevel gear 83 can be designed to be 0.3 times or more and 1.4 times or less, preferably 0.3 times or more and 1.0 times or less, the number of teeth of the fourth bevel gear 84; hence, a pitch cone angle θ (FIG. 3) of the fourth bevel gear 84 can be designed to be greater than 45 degrees. Thus, the axial dimension of the fourth bevel gear 84 can be reduced, and accordingly, a lengthwise dimension S (FIG. 1) of the head part 2 can be reduced.

If the number of teeth of the third bevel gear 83 is more than 1.4 times that of teeth of the fourth bevel gear 84, the lengthwise dimension S of the head is increased, which causes a problem that the tool 91 cannot reach, in particular, a back tooth when performing treatment thereon, and a new problem that wear or the like is intensified due to further speed increase, thus reducing the gear lifetime, and reducing the lifetime of the handpiece itself accordingly.

On the other hand, if the number of teeth of the third bevel gear 83 is less than 0.3 times that of teeth of the fourth bevel gear 84, the lengthwise dimension S of the head part 2 can be further reduced, but intermeshed surface of the teeth is reduced, which causes new problems that the durability of the third bevel gear 83 and the fourth bevel gear 84 is degraded, thus reducing the gear lifetime due to wear or the like when high-speed rotation is conducted, and reducing the lifetime of the handpiece itself accordingly.

Furthermore, in the handpiece 1 with the above-described structure, the turbine rotation shaft 55 can be rotated at a high speed, and therefore, there is no need to conduct speed increase by the first bevel gear 81 and the second bevel gear 82. Accordingly, in the handpiece 1 with the above-described structure, the number of teeth of the first bevel gear 81 can be designed to be equal to that of teeth of the second bevel gear 82, thus enabling the simplification of internal structure.

(2-2) Lubricating Oil Supply Mechanism

Upon supply of lubricating oil from a lubricating oil supply opening (not shown), the lubricating oil is supplied to the first bevel gear 81 and the second bevel gear 82 via the lubricating oil supply tube 439 and the hollow inner portion of the turbine rotation shaft 55, and is then supplied to the third bevel gear 83, the fourth bevel gear 84 and the rotor 24 via the hollow inner portion of the transmission rotation shaft 411. Thus, the lubrication of the first to fourth bevel gears 81 to 84 and the rotor 24 can be maintained.

The above-mentioned lubricating oil supply mechanism can be realized with a simple structure since it is only necessary to provide the lubricating oil supply tube 439 and to form the turbine rotation shaft 55 and the transmission rotation shaft 411, serving as components of the rotation transmission mechanism, into a hollow structure.

(2-3) Axial Flow Turbine 5

(2-3-1) Introduction Nozzle 51

The air flow, which has reached the introduction nozzle 51 of the axial flow turbine 5 through the air supply tube 433, flows into the first hole portions 61 of the introduction nozzle passages 6 to reach the connecting portion (i.e., fluid accumulation portion) 64, and then flows into each second hole portion 63 from the connecting portion 64 so as to be ejected from the respective openings 601, 602 and 603.

At this time, the air flow passing through the introduction nozzle passages 6 is moved as follows.

(a) Since the bottom face 621 of each groove portion 62 constituting the second hole portion 63 of the introduction nozzle passage 6 becomes shallower as it approaches the downstream side end face 514, the air flow is gradually constricted. Hence, the air flow runs at a high speed. Accordingly, the introduction nozzle 51 allows the high-speed air flow to be ejected from the introduction nozzle passages 6 toward the first turbine rotor 52.

(b) Since the space T between both the lateral faces 622 and 623 of the groove portion 62 constituting the second hole portion 63 becomes smaller as it approaches the downstream side end face 514, the air flow is gradually constricted. Hence, also in this respect, the air flow runs at a high speed. Accordingly, the introduction nozzle 51 allows the high-speed air flow to be ejected from the introduction nozzle passages 6 toward the first turbine rotor 52.

(c) The air flow, which has reached the connecting portion 64 from the first hole portions 61, is momentarily accumulated in the connection portion 64, and then flows into the respective second hole portions 63. Hence, a large amount of the air flow flows into the second hole portions 63, and is constricted through the second hole portions 63. Therefore, also in this respect, the air flow runs at a high speed. Accordingly, the introduction nozzle 51 allows the high-speed air flow to be ejected from the introduction nozzle passages 6 toward the first turbine rotor 52.

(d) Since the portions A, B connected with the connecting portion 64 and the groove portions 62 constituting the second hole portions 63 are approximately C-chamfered and approximately R-chamfered, respectively, the connected portions A, B each have a smooth curved surface. Hence, the air flow smoothly flows from the connecting portion 64 to the second hole portions 63. Therefore, also in this respect, the air flow runs at a high speed. Accordingly, the introduction nozzle 51 allows the high-speed air flow to be ejected from the introduction nozzle passages 6 toward the first turbine rotor 52.

(e) Since the groove portions 62 constituting the second hole portions 63 are each formed so as to be inclined with respect to the axial direction, the introduction nozzle 51 can squirt each blade of the turbine main body portion 521 with the air flow at an effective angle. Accordingly, the introduction nozzle 51 can rotate the first turbine main body portion 521 at a high speed.

(f) Since the areas of the respective openings 601, 602 and 603 are equal to each other, the introduction nozzle 51 can uniformly squirt each blade of the first turbine main body portion 521 with the air flow. Accordingly, the introduction nozzle 51 can favorably rotate the first turbine main body portion 521.

As stated above, the introduction nozzle 51 can eject air flow at a higher speed from the introduction nozzle passages 6 toward the first turbine rotor 52, and can favorably rotate the first turbine main body portion 521 at a high speed.

Furthermore, the introduction nozzle passages 6 of the introduction nozzle 51 can be formed by forming the first hole portions 61 with a drilling process, and by forming the groove portions 62 constituting the second hole portions 63 with a cutting process such as an end milling process or the like. In other words, the groove portions 62 constituting the second hole portions 63 can be formed by performing a cutting process on the circumferential face 515 of the introduction nozzle main body portion 511. Hence, the groove portions 62 with any dimension, shape and directivity can be easily formed. Accordingly, the introduction nozzle 51 having high-performance nozzle characteristics can be easily realized.

(2-3-2) Guide Nozzle 53

The air flow discharged from the first turbine rotor 52 flows into the guide nozzle passages 7 of the guide nozzle 53, and reaches the second turbine rotor 54 through the guide nozzle passages 7.

At this time, the air flow is moved as follows. Specifically, in each groove portion 72 constituting the guide nozzle passage 7, the upstream side groove portion 73 is inclined as indicated by the arrow Y1 of FIG. 14 with respect to the axial direction so as to be approximately in parallel with the inclination direction of the downstream side portion of each blade of the first turbine rotor 52 with respect to the axial direction; therefore, the air flow discharged from the first turbine rotor 52 efficiently flows into the guide nozzle passages 7. Besides, the downstream side groove portions 74 are each inclined with respect to the axial direction so as to be approximately in parallel with the inclination direction of the upstream side portion of each blade of the second turbine rotor 54 with respect to the axial direction; therefore, the air flow, which has passed through the guide nozzle passages 7, is squirted to each blade of the second turbine rotor 54 at an effective angle. Accordingly, the guide nozzle 53 can guide the air flow, which has been discharged from the first turbine rotor 52, to the second turbine rotor 54 while maintaining the air flow at a high speed.

Furthermore, the guide nozzle passages 7 of the guide nozzle 53 can be formed by forming the groove portions 72 with a cutting process performed on the circumferential face 535 of the guide nozzle main body portion 531. Hence, the groove portions 72 with any dimension, shape and directivity can be easily formed. Accordingly, the guide nozzle 53 having high-performance nozzle characteristics can be easily realized.

(2-4) Third Bevel Gear 83 and Fourth Bevel Gear 84

The rotation of the transmission rotation shaft 411 is transmitted to the rotor 24 via the third bevel gear 83 and the fourth bevel gear 84.

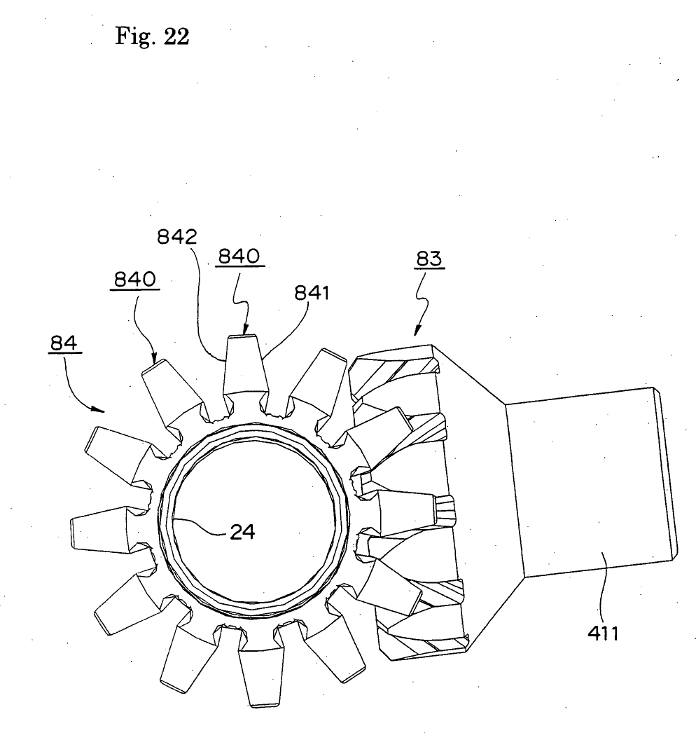

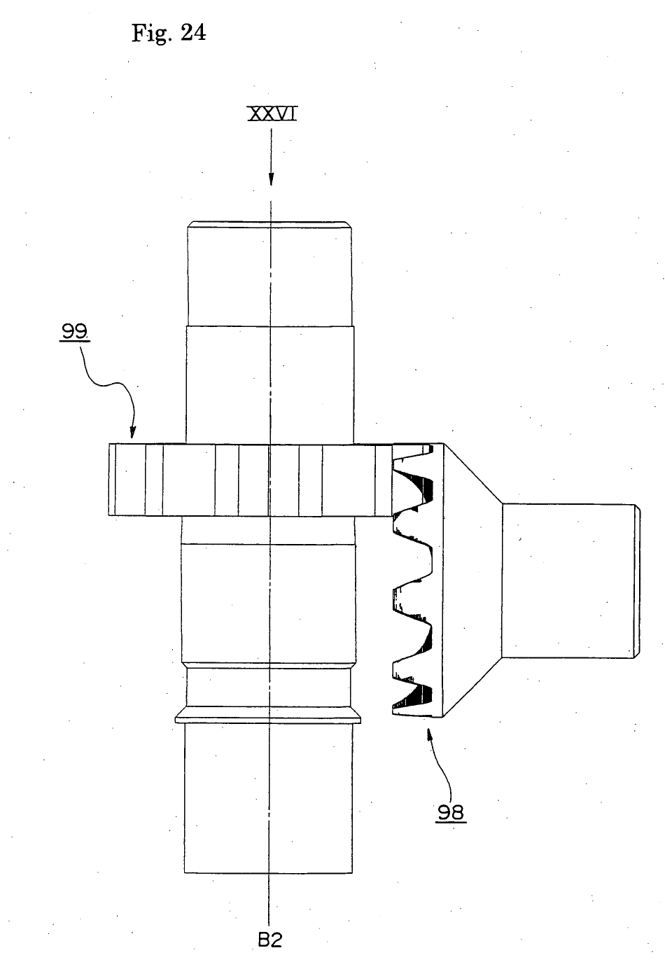

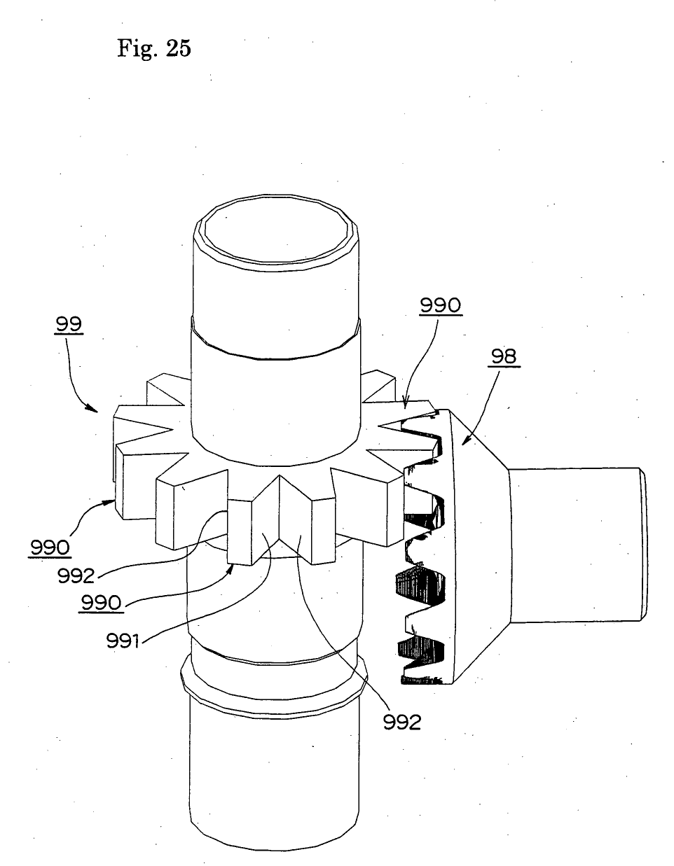

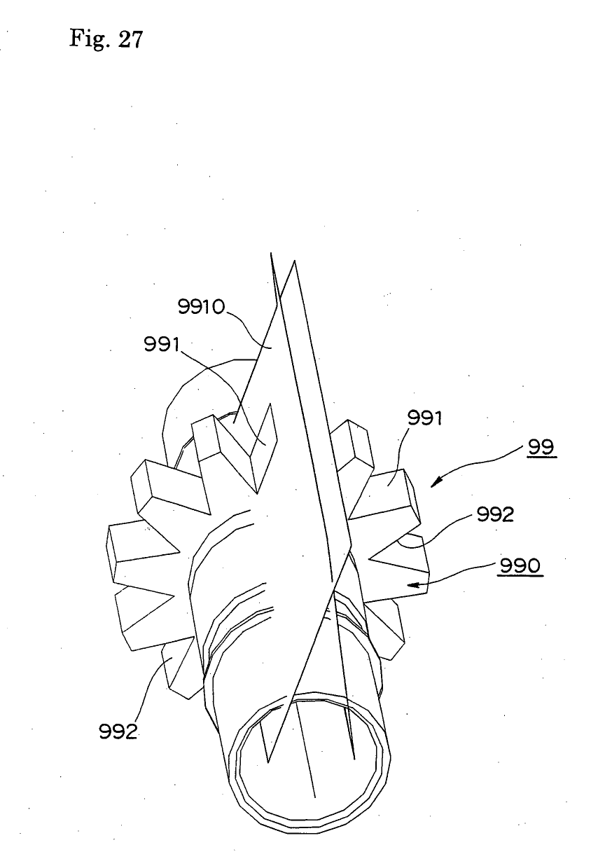

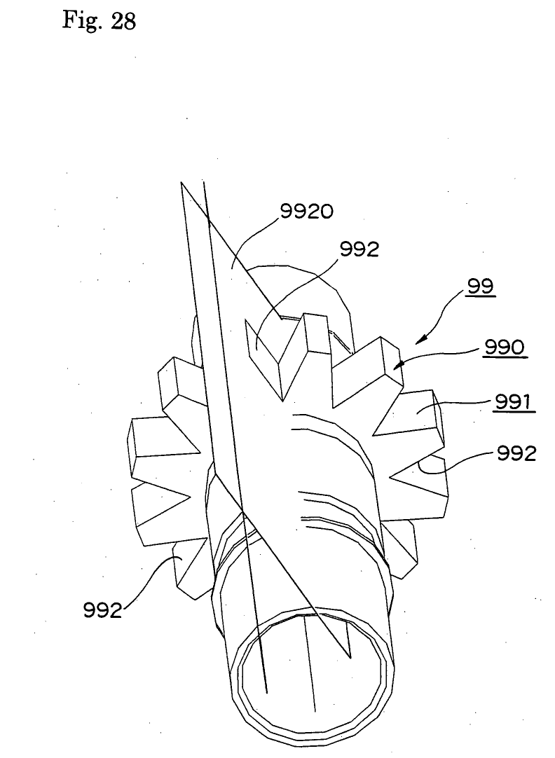

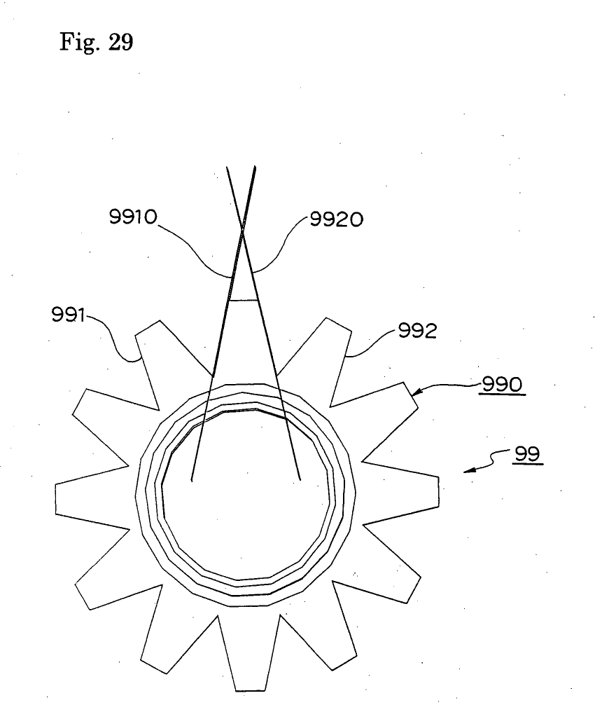

Actually, both the tooth surfaces 841, 842 of each tooth 840 of the fourth bevel gear 84 are each formed as described based on FIGS. 17 to 21. Hence, the intermeshed state of the third bevel gear 83 and the fourth bevel gear 84 is as shown in FIG. 22 that is a diagram viewed in the direction indicated by the arrow XXII of FIG. 17. On the other hand, in a pair of the conventional bevel gears shown in FIGS. 24 to 26, both the tooth surfaces 991, 992 of each tooth 990 of the driven-side bevel gear 99 are formed into flat surfaces, but as shown in FIGS. 27 to 29, the extended planes 9910, 9920, extended from both of the flat surfaces, are in parallel with the rotational center axis B2 of the bevel gear 99.

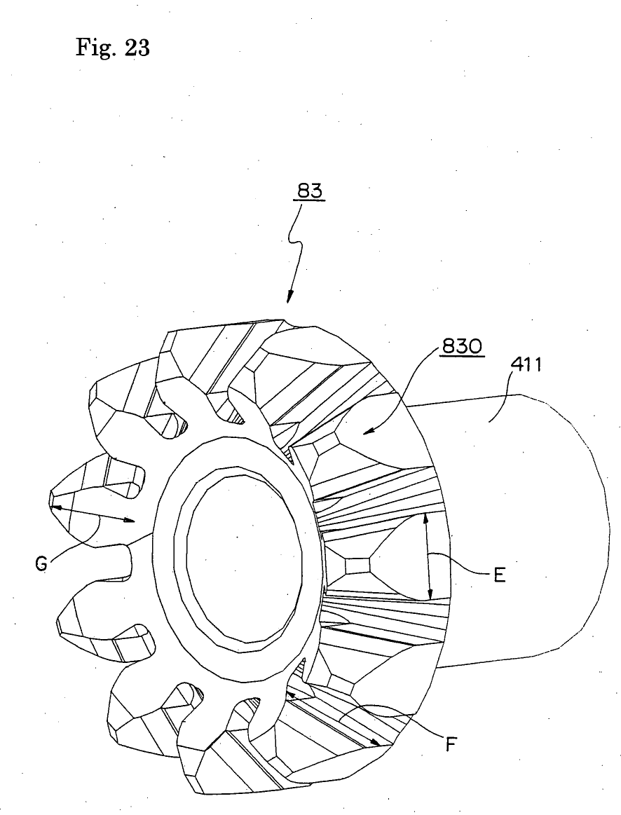

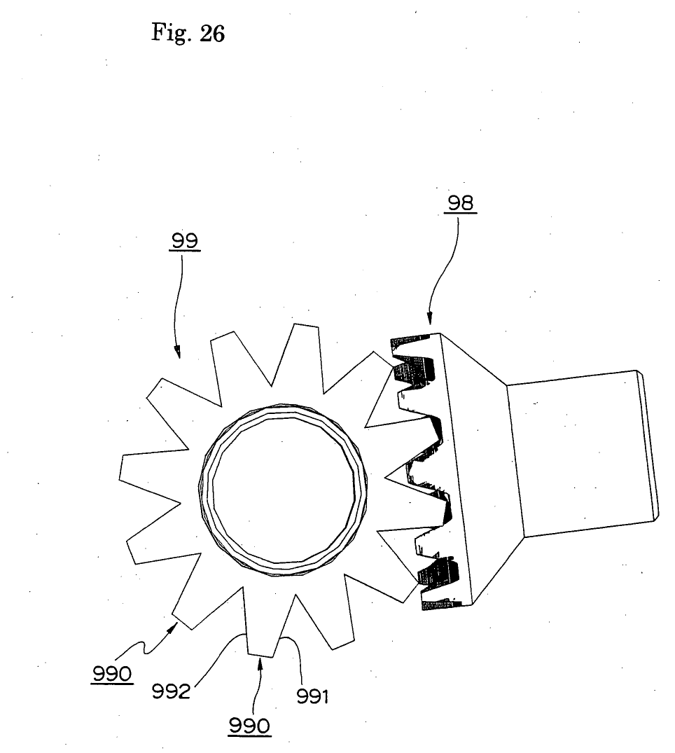

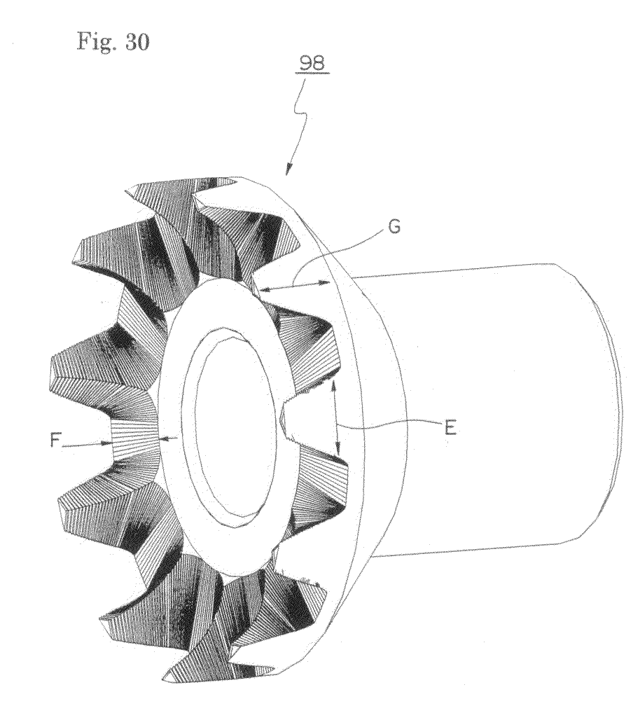

FIG. 23 is a perspective view of the driving-side third bevel gear 83 according to the present embodiment, and FIG. 30 is a perspective view of the driving-side bevel gear 98 according to the conventional example. Then, if a comparison is made between FIG. 22 showing the intermeshed state of the present embodiment and FIG. 26 showing the intermeshed state of the conventional example, and a comparison is made between the third bevel gear 83 of the present embodiment and the bevel gear 98 of the conventional example, the comparison results indicate that the third bevel gear 83 is designed such that all the tooth thickness E, tooth length F and tooth height G thereof are greater than those of the bevel gear 98. Hence, in the present embodiment, the durability of each tooth 830 of the third bevel gear 83 can be considerably improved, the third bevel gear 83 can be sufficiently intermeshed with the fourth bevel gear 84, and the intermeshed surface can be located on a pitch cone. Accordingly, in a pair of the third bevel gear 83 and the fourth bevel gear 84 of the present embodiment, wear, oscillation and the like can be suppressed. Further, the pitch cone angle θ (FIG. 3) of the fourth bevel gear 84 can be designed to be greater than 45 degrees.

In addition, since the point X1 coincides with the point X2, the tooth thickness of each tooth 830 of the third bevel gear 83 can be designed to be maximized.

Moreover, since the fourth bevel gear 84 is integrally formed with the rotor 24, the fourth bevel gear 84 can be fabricated by a simple cutting process.

Besides, since the number of teeth of the third bevel gear 83 differs from that of teeth of the fourth bevel gear 84, speed increase or speed reduction can be arbitrarily conducted.

Furthermore, since the pitch cone angle θ of the fourth bevel gear 84 is greater than 45 degrees, the axial dimension of the fourth bevel gear 84 can be reduced, and accordingly, the head part 2 in which the fourth bevel gear 84 is provided can be reduced in size.

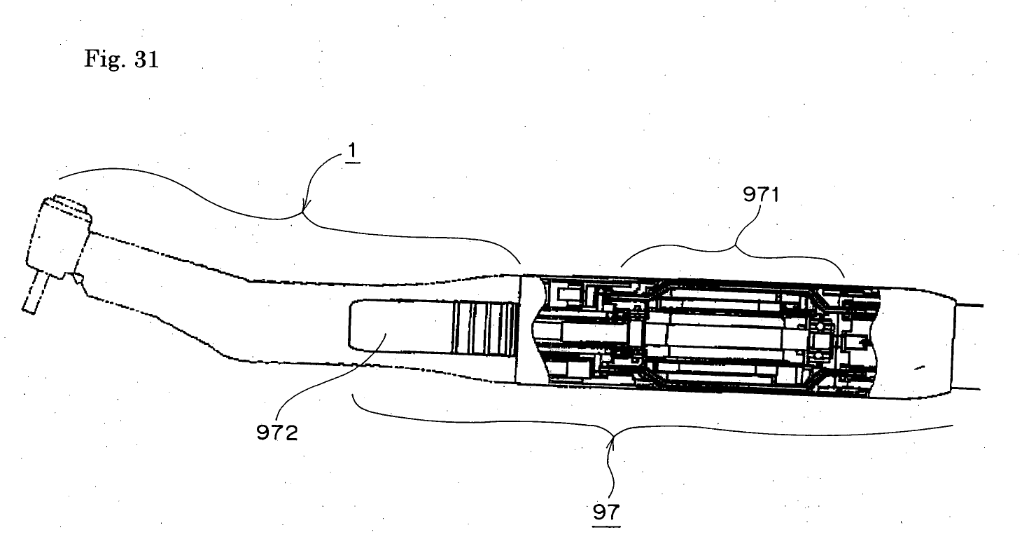

It should be noted that the medical/dental handpiece of the present embodiment is not limited to the above-described structures, but the following modified structures may be adopted.
(i) The axial flow turbine 5 may be provided in the front housing 41 or the center housing 42.
(ii) The number of the introduction nozzle passages 6 of the introduction nozzle 51 is not limited to three, but may be one to two, or four or more.
(iii) The number of the guide nozzle passages 7 of the guide nozzle 53 is not limited to six, but may be one to five, or seven or more.
(iv) Instead of the fourth bevel gear 84, the third bevel gear 83 may have the above-described structure concerning both the tooth surfaces 841, 842 of each tooth 840 of the fourth bevel gear 84. In that case, the following effects can be achieved.
(iv-1) The tooth thickness, tooth length and tooth height of each tooth 840 of the fourth bevel gear 84 can be all designed to be large. Hence, the durability of each tooth 840 of the fourth bevel gear 84 can be considerably improved; in addition, the third bevel gear 83 can be sufficiently intermeshed with the fourth bevel gear 84, and the intermeshed surface can be located on a pitch cone. Accordingly, wear, oscillation and the like can be suppressed. Further, the pitch cone angle of the third bevel gear 83 can be designed to be greater than 45 degrees.
(iv-2) Since the point X1 coincides with the point X2, the tooth thickness of each tooth 840 of the fourth bevel gear 84 can be designed to be maximized.
(iv-3) Since the pitch cone angle of the third bevel gear 83 can be designed to be greater than 45 degrees, the axial dimension of the third bevel gear 83 can be reduced, and accordingly, the axial dimension of the gripped part 3 in which the third bevel gear 83 is provided can be reduced.
(v) The orientation of the fourth bevel gear 84 may be inverted, and the intermeshed surface of the third bevel gear 83 and the fourth bevel gear 84 may be provided on a pitch cone closer to the tool 91.
(vi) Although the transmission rotation shaft 411 is rotationally driven by the axial flow turbine 5, the transmission rotation shaft 411 may be rotationally driven by a driving source 97 attached to a rear end of the handpiece 1 as shown in FIG. 31. The driving source 97 contains an electric motor 971 therein, and is detachably attached to the handpiece 1 by a one-touch engagement means 972.

### INDUSTRIAL APPLICABILITY

The medical/dental handpiece of the present invention is capable of rotating, at a high speed, a tool held at its head part without increasing the head part in size, and thus has valuable industrial applicability.

1. A medical/dental handpiece having an axial flow turbine, the handpiece characterized by comprising:
a head part that rotatably holds a holding shaft for detachably holding a tool; and
a gripped part that supports, at its front end, the head part, and that is gripped by an operator,
wherein the gripped part comprises a shank portion extending from the head part, and a body portion extending from a rear end of the shank portion in the direction of an obtuse angle,
wherein the axial flow turbine is contained in the gripped part, and
wherein the handpiece further comprises a rotation transmission mechanism for transmitting a rotation of the axial flow turbine to rotate the holding shaft of the head part.

2. The medical/dental handpiece according to claim 1,
wherein the rotation transmission mechanism is formed so as to transmit the rotation of the axial flow turbine to the holding shaft of the head part via a turbine rotation shaft, a first bevel gear, a second bevel gear, a transmission rotation shaft, a third bevel gear and a fourth bevel gear, and
wherein the third bevel gear is approximately orthogonally intermeshed with the fourth bevel gear.

3. The medical/dental handpiece according to claim 2,
wherein the number of teeth of the third bevel gear is 1.4 times or less that of teeth of the fourth bevel gear.

4. The medical/dental handpiece according to claim 2,
wherein the number of teeth of the third bevel gear is 1.0 times or less that of teeth of the fourth bevel gear.

5. The medical/dental handpiece according to claim 2,
wherein the number of teeth of the first bevel gear is equal to that of teeth of the second bevel gear.

6. The medical/dental handpiece according to claim 1,
wherein the axial flow turbine comprises: a plurality of turbine rotors; an introduction nozzle for introducing fluid to the turbine rotor while constricting the fluid therethrough; and one or more guide nozzles for guiding the fluid, which has been discharged from the turbine rotor, to the next turbine rotor.

7. The medical/dental handpiece according to claim 2,
wherein the gripped part has a lubricating oil supply mechanism,
wherein the lubricating oil supply mechanism is formed so as to supply a lubricating oil to the first to fourth bevel gears and the holding shaft through: a lubricating oil supply tube extending from a rear end portion of the body portion to a rear end of the turbine rotation shaft; a hollow inner portion of the turbine rotation shaft; and a hollow inner portion of the transmission rotation shaft.

8. The medical/dental handpiece according to claim 1,
wherein the rotation transmission mechanism has a pair of bevel gears for connecting the transmission rotation shaft, provided inside the gripped part, with the holding shaft of the head part,
wherein rotational center axes of the pair of bevel gears are approximately orthogonal to each other, and are intersected at a first point,
wherein both tooth surfaces of each tooth of one bevel gear are formed into flat surfaces,
wherein both of the flat surfaces are formed so that extended planes extended from the flat surfaces intersect, at a second point, with an extension of the rotational center axis of said one bevel gear, and
wherein the second point is located at the same side as the first point with respect to said one bevel gear.

9. The medical/dental handpiece according to claim 8,
wherein the first point coincides with the second point.

10. The medical/dental handpiece according to claim 8,
wherein said one bevel gear is provided at the holding shaft.

11. The medical/dental handpiece according to claim 10,
wherein said one bevel gear is formed integrally with the holding shaft.

12. The medical/dental handpiece according to claim 8,
wherein said one bevel gear is provided at the transmission rotation shaft.

13. The medical/dental handpiece according to any one of claims 10 to 12,
wherein the number of teeth of said one bevel gear differs from that of teeth of the other bevel gear.

14. The medical/dental handpiece according to any one of claims 10 to 12,
wherein a pitch cone angle of said one bevel gear exceeds 45 degrees.

15. A medical/dental handpiece comprising:
a head part that rotatably holds a holding shaft for detachably holding a tool; and
a gripped part that supports, at its front end, the head part, and that is gripped by an operator,
the gripped part comprising a shank portion extending from the head part, and a body portion extending from a rear end of the shank portion in the direction of an obtuse angle,
the medical/dental handpiece characterized by further comprising a rotation transmission mechanism for transmitting a rotation from a driving source to rotate the holding shaft of the head part,
wherein the rotation transmission mechanism has a pair of bevel gears for connecting the transmission rotation shaft, provided inside the gripped part, with the holding shaft of the head part,
wherein rotational center axes of the pair of bevel gears are approximately orthogonal to each other, and are intersected at a first point,
wherein both tooth surfaces of each tooth of one bevel gear are formed into flat surfaces,
wherein both of the flat surfaces are formed so that extended planes extended from the flat surfaces intersect, at a second point, with an extension of the rotational center axis of said one bevel gear, and
wherein the second point is located at the same side as the first point with respect to said one bevel gear.

16. The medical/dental handpiece according to claim 15,
wherein the first point coincides with the second point.

17. The medical/dental handpiece according to claim 15,
wherein said one bevel gear is provided at the holding shaft.

18. The medical/dental handpiece according to claim 17,
wherein said one bevel gear is formed integrally with the holding shaft.

19. The medical/dental handpiece according to claim 15,
wherein said one bevel gear is provided at the transmission rotation shaft.

20. The medical/dental handpiece according to any one of claims 17 to 19,
wherein the number of teeth of said one bevel gear differs from that of teeth of the other bevel gear.

21. The medical/dental handpiece according to any one of claims 17 to 19,
wherein a pitch cone angle of said one bevel gear exceeds 45 degrees.
